(19) United States
(12) Patent Application Publication
(10) Pub. No.: US 2004/0101671 A1
(43) Pub. Date: May 27, 2004

(54) In-line application of UV varnish

(75) Inventor: Thomas Rathschlag, Grossostheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/642,645

(22) Filed: Aug. 19, 2003

(30) Foreign Application Priority Data
Aug. 20, 2002 (DE) 102 39 020.7

(51) Int. Cl. B32B 19/00

(52) U.S. Cl. 428/221; 428/323; 428/332

(57) ABSTRACT

The present invention relates to a print product in which a layer of offset printing ink, a primer layer applied over the entire surface or over part of the surface and, as uppermost layer, a layer of UV-curable varnish applied over the entire surface or over part of the surface are located on a substrate, characterised in that the primer layer comprises platelet-shaped particles. The invention furthermore relates to a process for the production of the print product and to the use thereof as outer packaging or secondary packaging in the foods and cosmetics area.

The present invention relates to a print product having a substrate, a layer of an offset printing ink applied imagewise, a primer layer applied over the entire surface or over part of the surface, and a top layer of a UV-curable varnish applied over the entire surface or over part of the surface. It furthermore relates to a process for the production of the print product.

Print products produced by offset printing, in particular by sheet-fed offset printing, have already been known for some time. Printing inks which cure oxidatively, i.e. chemically, are usually employed in offset printing. In order to optimise the mechanical properties, the layer of offset printing ink is coated wet-on-wet with a water-based overprint varnish or a primer. This overprint varnish or primer is generally employed in the form of a dispersion. The dispersion can usually be applied by the chambered doctor blade method using an engraved roll. The engraved roll here is designed in such a way that the primer layer or overprint varnish layer achieves the highest possible weight of about 2-5 g/m² or more wet application. It is essential that the primer or overprint varnish has good firmness on the still not completely cured offset ink layer since it will otherwise sink into the offset ink. During drying of the primer or overprint varnish layer, the dispersion particles move closer together and join at the contact surfaces. This makes the surface significantly more scratch-resistant and gives it a lower tendency to block. However, ingress of oxygen is still possible, meaning that the offset printing ink can still cure completely within 24 hours. It is then normally no longer necessary to apply powders to the prints coated with primer or overprint varnish. At the least, their amount can be greatly reduced. Very generally, powders have the disadvantage of reducing the gloss and abrasion resistance. The production of glossy substrate surfaces follows the principle of economic efficiency. In order to increase the capacity of sheet-fed offset printing machines to their limit of 15,000 sheets or more per hour, the sheets printed with the offset printing ink are frequently coated in-line with a full-area layer of a UV-curable varnish.

However, a combination of layers of a water-based primer and UV-curable varnish results in problems since the physical and chemical curing mechanisms clash with one another. The water-based primer cures physically, while the UV varnish cures chemically. However, the cured UV varnish has only low oxygen permeability, and consequently the underlying offset printing ink can only cure slowly through oxidation. The UV varnish layer acts in practice like a cover film. Since the individual layers are applied very rapidly one after the other (at intervals of 1 second or less) in an in-line process, the UV varnish layer may sink into the primer layer. The primer layer may likewise sink into the underlying offset printing ink.

It has now been found that the problem of sinking can be solved by means of platelet-shaped particles incorporated into the primer layer. The particles are generally colorless and non-hiding, e.g., substantially clear, after drying. Otherwise they would impair the hue and gloss of the image produced with the offset printing ink.

The present invention accordingly relates to a print product having a substrate, a layer of an offset printing ink applied imagewise, i.e., printing an image or text onto a surface, a primer layer applied over the entire surface or over part of the surface, and a top layer of a UV-curable varnish applied over the entire surface or over part of the surface, wherein varnish can be applied to an area where no primer layer is present, which product is characterised in that the primer layer comprises platelet-shaped particles.

The length or width of the particles is generally from 1 to 1000 μm, preferably from 5 to 600 μm and particularly preferably from 1 to 200 μm. The thickness is from 0.05 to 10 μm and preferably from 0.1 to 2 μm. The particles firstly effectively prevent the UV varnish from sinking into the primer layer and secondly cause a significant improvement in the optical impression of the print products.

On the one hand, the platelet-shaped particles can be colorless particles or particles which are non-hiding after drying, in particular phyllosilicates, such as, for example, kaolin, natural or synthetic mica, talc, titanium dioxide platelets, aluminium oxide platelets, silicon dioxide platelets, glass platelets, Fe₂O₃ platelets or wax. Mica particles are particularly preferred.

On the other hand, the platelet-shaped substrates can be effect pigments. The term effect pigments here is taken to mean, in particular, pearlescent pigments, metal-effect pigments, multilayered pigments having transparent or transparent and opaque layers, holographic pigments, BiOCl and LCP (liquid crystal polymer) pigments.

Particular preference is given to primer layers comprising pearlescent pigments based on platelet-shaped, transparent or semi-transparent substrates. Suitable substrates are, for example, phyllosilicates, such as natural or synthetic mica or other silicate materials, glass, talc, sericite, kaolin, SiO₂ platelets, glass platelets, TiO₂ platelets, Fe₂O₃ platelets or Al₂O₃ platelets. The platelet-shaped substrates are coated, for example, with rare-earth metal sulfides, such as, for example, Ce₂S₃, titanium suboxides, titanium oxynitrides, pseudobrookite, with colored or colorless metal oxides, such as, for example, TiO₂, Fe₂O₃, Fe₃O₄, SnO₂, Cr₂O₃, ZnO, CuO, NiO and other metal oxides, alone or mixed in a uniform layer or in successive layers (multilayered pigments). Pearlescent pigments are disclosed, for example, in the German patents and patent applications 14 67 468, 19 59 998, 20 09 566, 22 14 454,22 15 191, 22 44 298, 23 13 331, 25 22 572, 31 37 808, 31 37 809, 31 51 343, 31 51 354, 31 51 355, 32 11 602, 32 35 017 and P 38 42 330 and are commercially available, for example under the trade name Iriodin® from Merck KGaA, Darmstadt. Multilayered pigments based on mica are marketed, for example, by Merck or EM Industries under the trade names Timiron® Splendid Copper, Timiron® Splendid Gold, Timiron® Splendid Red, Timiron® Splendid Violett, Timiron® Splendid Blue or Timiron® Splendid Green and Iriodin® Solargold.

Particularly preferred printing inks comprise TiO₂—, Fe₂O₃— or TiO₂/Fe₂O₃— coated mica, Al₂O₃ or SiO₂ platelets.

The SiO₂ platelets can be coated, for example, as described in WO 93/08237 (wet-chemical coating) or DE-A 196 14 637 (CVD process). Al₂O₃ platelets are disclosed, for example, in EP 0 763 573 A1. Platelet-shaped substrates coated with one or more rare-earth metal sulfides are disclosed, for example, in DE-A 198 10 317.

Also suitable are metal-effect pigments, in particular aluminium platelets modified for water-based systems, as marketed by Eckart under the trade name Rotovario Aqua® or Stapa Hydroxal® for water-based applications, and Variocrom® and Paliocrom® pigments from BASF, in particular also those from the laid-open specifications EP 0 681 009 A1, EP 0 632 110 A1, EP 0 634 458 A1 and LCP (liquid crystal polymer) pigments. Suitable effect pigments from BASF are, for example, Variocrom ED 1478, Variocrom ED 1479, Variocrom ED 1480. Likewise suitable are all holographic pigments and platelet-shaped pigments with metal layers known to the person skilled in the art. Pigments of this type are marketed, inter alia, by the Flex company, for example under the trade names Chromaflair Red/Gold 000, Chromaflair Gold/Silver 080, Chromaflair Green/Purple 190 and Chromaflair Silver/Green 060. The Chromaflair pigments having a particle size of about 11-13 μm consist of an opaque aluminium core and a magnesium fluoride layer of varying layer thickness which generates the later interference color of the pigment to be produced. A semi-transparent chromium layer is also applied as the outermost layer.

The primer layers may comprise one or more effect pigments. Particular color and gloss effects can often be achieved through the use of at least two different effect pigments. Preferred printing inks comprise one or two, furthermore three, effect pigments, in particular those based on mica and/or SiO₂ platelets. Blends of the effect pigments with organic and inorganic pigments in an amount of up to 10% by weight, based on the binder, are also possible, where the total amount of pigment should not exceed 90% by weight, based on the binder. Blending enables color flops to be set very specifically. In particular, the addition of one or more dyes and/or organic pigments in ground form results in special color effects. Furthermore, substances and particles (tracers) which enable product identification can be added.

Platelet-shaped particles or platelet-shaped effect pigments based on transparent or semi-transparent support materials which are colorless or non-hiding after drying may, in addition, also be incorporated into the UV varnish layer. The particles or pigments here may be identical with or different from those in the primer layer. In a particularly preferred embodiment, the primer layer comprises finely divided pearlescent pigments based on mica, and the UV varnish layer comprises particles which are colorless or non-hiding after drying. In order to achieve particularly uniform color effects, it has, in addition, proven favorable for the particles in the UV varnish layer to be larger than the pigments in the underlying primer layer. Surprisingly, the effect pigments act not only as spacers which prevent the primer layer from sinking into the offset ink layer, but also significantly improve the optical impression of the print product. This is attributed to the platelet-shaped pigment particles aligning in the primer layer applied wet-on-wet by the engraved roll before the UV varnish is applied in the subsequent working step. The optical impression is then comparable with that of automotive paints.

It is also possible to incorporate effect pigments, in particular pearlescent pigments, into the UV varnish layer. The problem of alignment of the effect pigment particles in UV varnishes which usually arises is significantly improved by the spacers integrated in the primer layer. This applies in particular if the UV varnish is applied by the chambered doctor blade method using an engraved roll. On use of this process, the alignment of the effect pigment particles in the UV varnish layer is more uniform and thus better than in the case of application using a smooth roll in a coating unit of a coating machine. In this other application method, the pigment particles frequently aggregate together in an undesired manner and form pigment agglomerates, which can result in a high reject rate.

The disadvantage of a lengthened flow zone can be substantially compensated for since the effect UV varnish, in comparison with emulsion overprint varnishes, is usually cured directly after application using UV light having a wavelength of from 250 to 400 nm.

In a further embodiment, effect pigments, in particular pearlescent pigments based on mica, are present in the offset ink, in the primer layer and in the UV varnish layer. The individual layers thereby become particularly homogeneous and uniform in thickness. The primer layer and UV varnish layer are advantageously applied with the aid of the chambered doctor blade method. The size of the pigment particles in the individual layers may be graduated in a similar manner to the embodiment already described above. In order to achieve an optimum color effect, the pigment particles in the primer layer should be larger than those in the offset printing ink, and pigment particles in the UV varnish layer should in turn be larger than those in the primer layer. Pigments having a particle size fraction of from 5 to 25 μm (for example Iriodin® 123 from Merck KGaA) have proven advantageous in offset printing inks, pigments having a particle size fraction of from 10 to 60 μm (for example Iriodin® 103) have proven advantageous in the primer layer, and pigments having a particle size fraction of from 20 to 100 μm (for example Iriodin® 153) have proven advantageous in the UV varnish layer. In addition, the content of (effect) pigment should decrease from the offset ink layer via the primer layer to the UV-curable varnish layer in order that the individual effects do not mask one another.

On printing of offset inks with high ink coverage, a significant reduction in 10 gloss usually occurs after overprinting of water-based primers with UV varnishes if the degree of gloss is measured within the first 24 hours. This is associated with the fact that the incompletely cured UV varnish sinks into the offset ink and is not effectively prevented from doing so by the water-based primer. This problem can be solved by a UV-curable primer layer. Still more favorable is a free-radical UV-curable primer layer comprising a dispersion which can be physically dried even before the UV curing. Due to the spontaneous hardening of the primer layer through IR radiation or through hot air, rapid film formation occurs. The degree of crosslinking of the polymers in the primer layer is subsequently increased again through the use of UV rays during hardening of the UV varnish, since they can also reach the free-radical photoinitiator in the water-based primer layer. Sinking of the primer into the offset ink is thereby reduced further.

In a particular embodiment, the primer layer additionally comprises at least one crosslinking agent which ensures rapid curing. Suitable are, for example, CX 100 polyaziridine crosslinking agents from Zeneca. An even shorter crosslinking time of the primer can thus be achieved. The risk of the primer sinking into the offset printing ink is thus minimised still further.

Due to the incorporation of mica particles or pearlescent pigments based on mica into the primer, an optimum in gloss retention of the UV varnish in the case of inks with high ink coverage is achieved during storage for more than 24 hours. The dependence of the ink-absorption behaviour (a property of the printing ink) in the case of the use of different print materials is significantly lower. The pigment coating or the finishing of the board surface no longer plays a dominant role in the interaction of the differently curing ink/varnish systems in UV in-line varnish application.

The present invention furthermore relates to a process for the production of the print product according to the invention.

In this process, a substrate or print material (for example of paper, board, fabric or plastic) is printed by offset printing, then coated with a water-based primer and finally with a UV varnish. The process is characterised in that the primer comprises platelet-shaped pigments and/or effect pigments which are transparent or non-hiding after drying. If desired, effect pigments, in particular pearlescent pigments, can be added to the offset printing ink. The primer and UV varnish are particularly favourably applied with the aid of the chambered doctor blade method.

The free-radical-curable UV varnish meets the provisions of clauses 30 and 31 of the act on trade in foods, tobacco products, cosmetics and other requisites (German Foods and Requisites Act; last amended on 25.2.1998).

The print products according to the invention are therefore suitable, depending on the type of print material, for a multiplicity of applications. Examples are folding boxes (which serve, for example, for the outer packaging of foods or for the packaging of cosmetics).

The following examples serve to explain the invention. Percentages therein are per cent by weight, unless stated otherwise. The abbreviations have the following meanings:

SC=solids content (in per cent by weight)

TG glass transition temperature (in ° C.)

AN=acid number

m.p.=melting point

b.p.=boiling point

Fl.p.=flash point

MFT=minimum film-formation temperature.

The degree of gloss is measured using the Micro-Tri-gloss (20°/60°/85°) measuring instrument from Byk Gardener GmbH; measurement geometry: 60°.

The offset printing ink is applied to GD-2 board using a rubber roll. The colored offset ink (reference printing ink) used is Novavit® 2 F 83 Magenta on the Euroscale. A manual ink proofing kit from Indira Agencies (Bombay/India) is used.

The water-based primer and the UV varnish are each applied using a 6 μm coating bar from Erichsen, D-58675 Hemer.

The residual water from the primer or overprint varnish is removed using a Braun Style Professional hairdryer (1800 W, setting 3 for 2 sec.).

In order to simulate the wet-on-wet application method, the offset printing 25 ink, water-based primer and UV varnish are applied to the coated side of GD-2 board coated on one side. Application of the offset ink, the primer and the UV varnish are separated by an interval of not more than 1 second in order to simulate the in-line process.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

### PREPARATION EXAMPLE 1

Effect pigments based on mica are mixed into a water-based primer of the following composition:

| Water-based | | | |
|---|---|---|---|
| in-line | SC/ | | % by |
| primer | primer | System constituents | wt. |
| TR 09/00 | 30-45 | Acrylate resin, molecular weight: 1800, | 10-12 |
| | | acid number: 250, density: 1.17 g/cm³, | |
| | | SC: 100%, TG (° C.): 57 | |
| | | Demineralised water | 0-24 |
| | | Styrene/acrylate dispersion, SC: 44%, | 40-50 |
| | | pH: 8.2, AN: 65, density: 1.05 g/cm³; | |
| | | TG (° C.): 110, MFT: >86° C. | |
| | | Polyethylene wax dispersion: | 5-9 |
| | | SC: 40%, pH: 9.5, density: 0.99 g/cm³ | |
| | | Iriodin ^{®} 103, TiO₂ mica | 20-25 |
| | | pigment having a particle size of | |
| | | 10-60 μm from Merck KGaA | |
| | | Silicone antifoam: density: 0.88 g/cm³, | 0.1-1 |
| | | SC: 10%; fl.p.: 50° C.; | |

### PREPARATION EXAMPLE 2

A water-based primer composition comprising a colorless mica suspension is prepared from the following constituents:

| Water- | | | |
|---|---|---|---|
| based | | | |
| in-line | SC/ | | % by |
| primer | primer | System constituents | wt. |
| TR 10/00 | 30-45 | Acrylate resin, molecular | 10-20 |
| | | weight: 1800, acid number: 250,density: | |
| | | 1.17 g/cm³, SC: 100%, | |
| | | TG: 57° C. | |
| | | Styrene/acrylate dispersion, SC: 44%, | 60-80 |
| | | pH: 8.2, AN: 65, density: | |
| | | 1.05 g/cm³; TG: 110° C., | |
| | | MFT: >86° C. | |
| | | Polyethylene wax dispersion: SC: 40%, | 5-9 |
| | | pH: 9.5, density: 0.99 g/cm³ | |
| | | Mica suspension from Merck KGaA, | 10-15 |
| | | Darmstadt (16% in water), | |
| | | particle size: 40-45 μm | |
| | | Silicone antifoam: density: 0.88 g/cm³, | 0.1-0.60 |
| | | SC: 10%; fl.p.: 50° C.; | |
| | | Silicone polyether copolymer, | |
| | | SC: 100%, m.p.: 40° C., b.p.: > | |
| | | 150° C., density: 1.04 g/cm³ | |

### PREPARATION EXAMPLE 3

Pearl offset printing ink used: Litho-Set-Periglanz-Weiβ 51-013979-3 from Siegwerk Druckfarben, Siegburg. Primer used: as in Example 1; UV varnish used: TR 11/00 UV pearlescent varnish from Merck KGaA, Darmstadt.

This varnish consists of

75-85% by wt. of free-radical-curable varnish (®Senolith 360192 UV varnish from Weilburger Lackfabrik) and

15-25% by wt. of Iriodin® 153, TiO₂ mica pigment from Merck KGaA

### PREPARATION EXAMPLE 4

A UV-curing polyurethane dispersion primer is prepared. It is ensured that the primer layer is tack-free for the actual UV curing.

The TR12/00 polyurethane dispersion primer consists of

80-90% by wt. of an aliphatic polyurethane dispersion, 35% in water, viscosity: <250 mPa.s, anionically stabilised; pH: 7-8 (®Ebecryl IRR 400; manufacturer: UCB S.A., Drogenbos, Belgium),

10-15% by wt. of mica suspension from Merck KGaA, Darmstadt (16% in water), particle size: 40-45 μm, and

1-3% by wt. of a mixture of 50% of 1-hydroxycyclohexyl phenyl ketone with 50% of benzophenone (®lrgacure 500 from Ciba Speciality Chemicals, Switzerland) and as needed demineralised water for viscosity adjustment.

14 different print products are produced. The starting materials and production conditions are shown in the following table. The experiment numbers denoted by an asterisk (*) denote comparative experiments. In Example Nos. 12 to 14, only one primer layer or only one UV varnish layer is applied. The surface gloss immediately after application and/or after 24 hours is then determined for the individual print products. The results are shown in the final table.

| No. | Experiment | Composition |
|---|---|---|
| 1* | Reference printing ink; cured for 12 h | ® Novavit 2 F 83 Magenta on the |
| | at 23° C. | Euroscale from BASF |
| 2* | Reference printing ink + reference | ® Novavit 2 F 83 Magenta |
| | primer (drying: ink: 12 h at 23° C., | ® Senolith UV in-line primer 350010 |
| | primer 2 min at 80° C.) | from Weilburger Lackfabrik |
| 3* | Reference printing ink + reference | ® Novavit 2 F 83 Magenta |
| | primer + UV varnish (drying: ink + primer | ® Senolith UV in-line primer 350010 |
| | as under 2; UV varnish | ® Senolith 360192 UV varnish |
| | cured at 20 m/min using 2 Hg | |
| | medium-pressure lamps in the UV | |
| | channel from Beltron) | |
| 4* | Reference printing ink + reference | ® Novavit 2 F 83 Magenta |
| | primer (drying: ink: without intermediate | ® Senolith 350010UV in-line primer |
| | drying; primer: 2 s with | |
| | hairdryer) | |
| 5* | Reference printing ink + reference | ® Novavit 2 F 83 Magenta |
| | primer + UV varnish (drying: ink: | ® Senolith 350010UV in-line primer |
| | without intermediate drying; | ® Senolith 360192 UV varnish |
| | primer: 2 s with hairdryer; UV varnish: | |
| | without additional residence | |
| | time, cured at 20 m/min using 2 Hg | |
| | medium-pressure lamps in the UV | |
| | channel) | |
| 6 | Reference printing ink + TR 10/00 | ® Novavit 2 F 83 Magenta |
| | primer (drying: ink: 12 h at 23° C., | ® TR 10/00 UV in-line primer |
| | primer: 2 min at 80° C.) | (mica-based from Merck, Darmstadt) |
| 7 | Reference printing ink + TR 10/00 | ® Novavit 2 F 83 Magenta |
| | primer + UV varnish (drying: ink + primer | ® TR 10/00 UV in-line primer |
| | as under 2; UV varnish | (mica-based) |
| | cured at 20 m/min using 2 Hg | ® Senolith 360192 UV varnish |
| | medium-pressure lamps in the UV | |
| | channel) | |
| 8 | Reference printing ink + TR 10/00 | ® Novavit 2 F 83 Magenta |
| | primer (drying: ink: without intermediate | ® TR 10/00 UV in-line primer |
| | drying; primer: 2 s with | (mica-based) |
| | hairdryer) | |
| 9 | Proposed practical set-up: | ® Novavit 2 F 83 Magenta |
| | Reference printing ink + TR 10/00 | ® TR 10/00 UV in-line primer |
| | primer + UV varnish (drying: ink: | (mica-based) |
| | without intermediate drying; primer: | ® Senolith 360192 UV varnish |
| | 2 s with hairdryer; UV varnish: | |
| | cured at 20 m/min using 2 Hg | |
| | medium-pressure lamps in the UV | |
| | channel without additional residence | |
| | time | |
| 10* | Reference printing ink + reference | ® Novavit 2 F 83 Magenta |
| | primer + UV varnish (drying: ink + primer | Rhyner ® Galacryl 82.156.17 UV in- |
| | primer as under 2; UV varnish | line primer from Schmid |
| | cured at 20 m/min using 2 Hg | Rhyner ® Wessco 7015628 UV in- |
| | medium-pressure lamps in the UV | line varnish from Schmid |
| | channel) | |
| 11* | Reference printing ink + reference | ® Novavit 2 F 83 Magenta |
| | primer + UV varnish (drying: ink: | ® Galacryl 82.156.17 UV in-line |
| | without intermediate drying; | primer |
| | primer: 2 s with hairdryer; UV varnish: | ® Wessco 7015628 UV in-line |
| | cured at 20 m/min using 2 Hg | varnish |
| | medium-pressure lamps in the UV | |
| | channel without additional residence | |
| | time) | |
| 12* | Reference primer from Schmid | ® Galacryl 82.156.17 UV in-line |
| | Rhyner (primer dried for 2 min at | primer |
| | 80° C.) | |
| 13* | TR 10/00 primer | ® TR 10/00 UV in-line primer |
| | (primer dried for 2 min. at 80° C.) | (mica-based) |
| 14* | UV varnish (drying: cured at | ® Senolith UV varnish 360192 |
| | 20 m/min using 2 Hg medium-pressure | |
| | lamps in the UV channel) | |

### Determination of Degree of Gloss

| Experiment | 60° degree of gloss/ | | 60° degree of gloss/ | |
|---|---|---|---|---|
| number | immediately | | after 24 h | |
| 1* | | | transv.: | 43.4 (on black) |
| | | | long.: | 49.5 (on black) |
| | | | transv.: | 37.6 (on white) |
| | | | long.: | 46.0 (on white) |
| 2* | | | transv.: | 45.9 (on black) |
| | | | long.: | 55.0 (on black) |
| | | | transv.: | 48.3 (on white) |
| | | | long.: | 55.6 (on white) |
| 3* | | | transv.: | 81.5 (on black) |
| | | | long.: | 83.9 (on black) |
| | | | transv.: | 74.7 (on white) |
| | | | long.: | 71.9 (on white) |
| 4* | transv.: | 41.8 (on black) | | |
| | long.: | 52.5 (on black) | | |
| | transv.: | 54.8 (on white) | | |
| | long.: | 61.9 (on white) | | |
| 5* | transv.: | 82.1 (on black) | | |
| | long.: | 87.4 (on black) | | |
| | transv.: | 85.0 (on white) | | |
| | long.: | 86.7 (on white) | | |
| 6 | | | transv.: | 66.2 (on black) |
| | | | long.: | 74.3 (on black) |
| | | | transv.: | 65.6 (on white) |
| | | | long.: | 62.6 (on white) |
| 7 | | | transv.: | 83.3 (on black) |
| | | | long.: | 85.9 (on black) |
| | | | transv.: | 84.4 (on white) |
| | | | long.: | 87.3 (on white) |
| 8 | transv.: | 64.9 (on black) | | |
| | long.: | 73.6 (on black) | | |
| | transv.: | 63.4 (on white) | | |
| | long.: | 60.4 (on white) | | |
| 9 | transv.: | 84.1 (on black) | | |
| | long.: | 87.1 (on black) | | |
| | transv.: | 89.7 (on white) | | |
| | long.: | 91.5 (on white) | | |
| 10* | | | transv.: | 84.6 (on black) |
| | | | long.: | 83.6 (on black) |
| | | | transv.: | 75.9 (on white) |
| | | | long.: | 80.4 (on white) |
| 11* | transv.: | 84.6 (on black) | | |
| | long.: | 83.6 (on black) | | |
| | transv.: | 76.7 (on white) | | |
| | long.: | 76.7 (on white) | | |
| 12* | | | transv.: | 75.2 (on black) |
| | | | long.: | 80.1 (on black) |
| | | | transv.: | 65.7 (on white) |
| | | | long.: | 71.3 (on white) |
| 13* | | | transv.: | 66.8 (on black) |
| | | | long.: | 62.5 (on black) |
| | | | transv.: | 68.2 (on white) |
| | | | long.: | 65.9 (on white) |
| 14* | transv.: | 92.3 (on black) | transv.: | 90.7 (on black) |
| | long.: | 90.6 (on black) | long.: | 89.0 (on black) |
| | transv.: | 91.5 (on white) | transv.: | 88.0 (on white) |
| | long.: | 93.1 (on white) | long.: | 85.7 (on white) |

The entire disclosures of all applications, patents and publications, cited herein and of corresponding German application No. 10239020.7, filed on Aug. 20, 2002 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A print product comprising a substrate, a layer of an offset printing ink applied imagewise, a primer layer, and a top layer of a UV-curable overprint varnish, wherein the primer layer comprises platelet-shaped particles.

2. A print product according to claim 1, wherein the particles are colorless or are non-hiding after drying.

3. A print product according to claim 1, wherein the length or width of the particles is 1 to 1000 μm and the thickness is 0.05 to 10 μm.

4. A print product according to claim 1, wherein the particles comprise kaolin, natural or synthetic mica, talc, titanium dioxide, aluminum oxide, glass or wax.

5. A print product according to claim 1, wherein the platelet-shaped particles are effect pigments.

6. A print product according to claim 5, wherein the effect pigments are pearlescent pigments based on a silicate material or are Fe₂O₃ platelets or Al₂O₃ platelets with one or more coatings of one or more metal oxides.

7. A print product according to claim 5, wherein the effect pigments are pearlescent pigments based on natural or synthetic mica, talc, sericite, or kaolin, SiO₂ platelets, glass platelets, Fe₂O₃ platelets or Al₂O₃ platelets with one or more coatings of rare-earth metal sulfides, or with one or more colored or colorless metal oxides selected from the group consisting of titanium dioxide, titanium suboxide, titanium oxynitride, pseudobrookite, Fe₂O₃, Fe₃O₄, SnO₂, Cr₂O₃, ZnO, CuO, and NiO, and a mixture thereof.

8. A print product according to claim 1, wherein the varnish layer comprises platelet-shaped particles.

9. A print product according to claim 1, wherein the primer layer comprises pearlescent pigments based on mica, and the varnish layer comprises particles which are colorless or non-hiding after drying.

10. A print product according to claim 1, wherein the offset ink, the primer layer and the varnish layer comprises effect pigments.

11. A print product according to claim 1, wherein the primer layer is chemically curable and comprises at least one crosslinking agent.

12. A print product according to claim 1, wherein the primer layer is a water based primer layer.

13. A print product according to claim 1, wherein the particles comprise mica.

14. A print product according to claim 1, wherein the varnish layer comprises platelet-shaped particles that are larger than the particles in the primer layer.

15. A process for preparing a print product that is according to claim 1, comprising printing the substrate in-line by offset printing, then coating the support with the primer and then with the varnish.

16. A process according to claim 15, wherein the primer layer is a water-based primer layer.

17. A process according to claim 15, wherein the primer comprises platelet-shaped pigments or effect pigments which are transparent or non-hiding after drying.

18. A process according to claim 15, wherein the offset printing ink, the primer and/or the UV varnish comprises effect pigments.

19. A food or cosmetic product packaging comprising a print product according to claim 1.

20. A folding box comprising a print product according to claim 1.
